(19) United States
(12) Patent Application Publication
(10) Pub. No.: US 2010/0205565 A1
(43) Pub. Date: Aug. 12, 2010

(54) DISPLAY DEVICE

(75) Inventor: Hiroki Sugamata, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/702,811

(22) Filed: Feb. 9, 2010

(30) Foreign Application Priority Data
Feb. 12, 2009 (JP) 2009-030457

(51) Int. Cl. G06F 3/048

(52) U.S. Cl. 715/835

(57) ABSTRACT

A display device includes a display unit, an information acquisition unit, and a display control unit. The information acquisition unit acquires list information containing title information on a plurality of data files or information corresponding to the title information. The display control unit displays a title list which is a list of the title information on the data files on the display unit based on the list information acquired by the information acquisition unit. In the display device, the list information contains information on security setting for every data file. The display control unit, in displaying the title list on the display unit, displays predetermined information in place of the title information based on the information on security setting with respect to the data file to which security setting is given.

### CROSS-REFERENCE TO RELATED APPLICATIONS

This application is based on and claims the benefit of priority from Japanese Patent Application No. 2009-030457 filed on Feb. 12, 2009, the entire contents of which are incorporated herein by reference.

### BACKGROUND

1. Field

The present invention relates to a display device, and more particularly to a display device which can display a title list which is a list of title information on data files.

2. Description of the Related Art

Conventionally, there has been known a display device such as an electronic book which reads any one of data file from a plurality of data files stored in a memory unit and displays an image which corresponds to the data file.

To show what kinds of data files are stored in the memory unit to a user, the above-mentioned display device has a function of allowing a display unit to display a title list which is a list of title information on data files stored in the memory unit.

As a method of displaying the title list, there has been known a method which displays titles of data files by sequentially rearranging the data files in order from the data file of a longest cumulative display time to the data file of a shortest cumulative display time. Further, as another method of displaying the title list, there has been known a method which displays titles of data files by rearranging the data files corresponding to content of an operation performed by a user. In this manner, there have been made several proposals which allow a display device to display data files in order of the importance of the data files for a user.

With respect to the above-mentioned display device, there may be a case where a person other than an owner of the display device uses the display device due to temporary lending, missing or the like. As a countermeasure to cope with such a case, in general, data files which the owner wants to conceal are encrypted or the like and are stored in a memory unit of the display device.

Further, there has been also made a proposal of a display device where a predetermined page of a data file to which protection setting is not given is displayed with a thumbnail icon as a reduced image, and a data file to which protection setting is given is displayed with an icon which indicates that the data file is in a protection state.

### SUMMARY

However, in the conventional display device, although the data file is encrypted or the icon which indicates that the data file is in a protection state is displayed, title information is not protected by the above-mentioned methods. Accordingly, there may be a possibility that, when the title list is displayed, a third party other than an owner of the display device estimates what kind data file is stored in the memory unit of the display device based on the title information.

The present invention has been made under the above-mentioned circumstances, and it is an object of the present invention to provide a display device which can ensure confidentiality of data files when a title list which is a list of title information on data files is displayed.

To achieve the above-mentioned object, according to one aspect of the present invention, there is provided a display device which includes a display unit, an information acquisition unit, and a display control unit. The information acquisition unit acquires list information containing title information on a plurality of data files or information corresponding to the title information. The display control unit displays a title list which is a list of the title information on the data files based on the list information acquired by the information acquisition unit on the display unit. The list information contains information on security setting for every data file. The display control unit, in displaying the title list on the display unit, displays predetermined information in place of the title information with respect to the data file to which security setting is given based on the information on security setting.

### BRIEF DESCRIPTION OF THE DRAWINGS

FIG. 1 is a plan view showing an appearance of a display device according to one embodiment of the present invention;

FIG. 2 is a view showing a hierarchical state of folders and data files;

FIG. 3A to FIG. 3G are views for explaining an operation for displaying a title list of the folders;

FIG. 4A to FIG. 4F are views for explaining an operation for displaying a title list of browsing history;

FIG. 5 is a constitutional view of the display device;

FIG. 6 is a view showing the data structure of a top folder file;

FIG. 7 is a view showing the data structure of a folder file;

FIG. 8 is a view showing the data structure of a document file;

FIG. 9 is a view showing a hierarchical state of folders and data files;

FIG. 10 is a view showing the data structure of a browsing history file;

FIG. 11A and FIG. 11B are views for explaining updating of the browsing history file;

FIG. 12A and FIG. 12B are flowcharts showing the flow of main control processing of the display device;

FIG. 13A to FIG. 13C are flowcharts showing the flow of main folder processing;

FIG. 14A and FIG. 14B are flowcharts showing the flow of list selection processing;

FIG. 15A and FIG. 15B are flowcharts showing the flow of browsing history display processing; and

FIG. 16A and FIG. 16B are flowcharts showing the flow of browsing history selection processing.

### DETAILED DESCRIPTION

Hereinafter, a display device according to one embodiment of the present invention is explained in conjunction with drawings.

### [1. Overall Structure of Display Device]

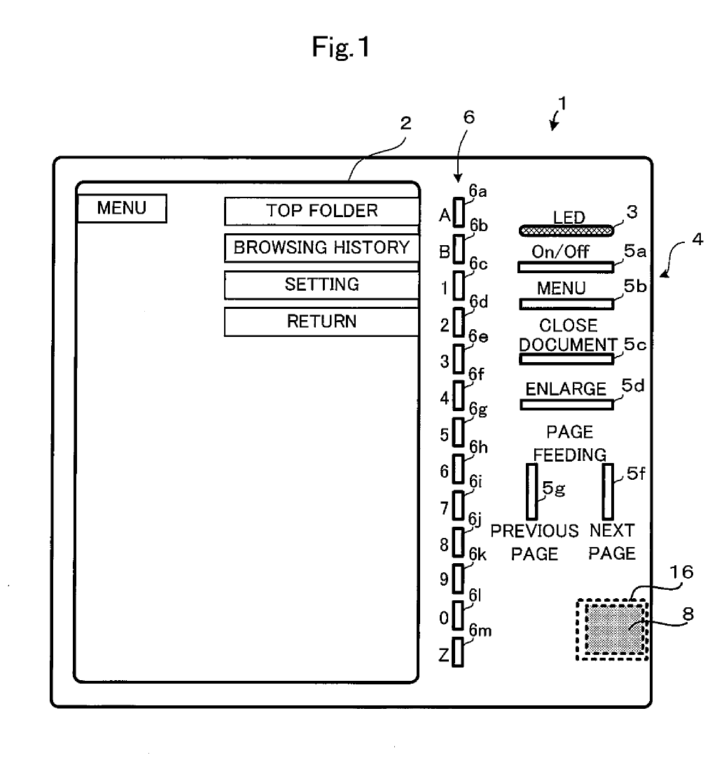

Firstly, the appearance and main operations of the display device 1 according to this embodiment is explained in conjunction with FIG. 1 to FIG. 4.

The display device 1 is a thin device having a rectangular shape in a plan view. As shown in FIG. 1, on a front surface of the display device 1, a display part 2 having a size of approximately A4 size is mounted as a display unit. The display part 2 is constituted of an electrophoresis display panel or a liquid crystal panel (LCD), for example.

In such a display device 1, on a right side of the display part 2, an LED 3 which indicates a state of the display device 1, and an operation part 4 provided with various kinds of operation buttons are arranged. The operation part 4 includes a power source button 5a, a menu button 5b, a document closure button 5c, an enlargement button 5d, page scrawling buttons 5f, 5g and region selection buttons 6 (6a to 6m).

A user of the display device 1 can perform selection, display, preparation and the like of data files to be displayed on the display part 2 by operating the operation part 4. As “data file” which can be handled in the display device 1 of this embodiment, a data file for displaying a document constituted of characters, figures and the like (hereinafter referred to as “document file”), or a data file for displaying graphic images such as photographs or CGs is named. However, the data file is not limited to such files. Hereinafter, for facilitating the explanation of this embodiment, the explanation is made with respect to a case where the document file is used as the data file.

On a right-side surface of the display device 1, a memory card interface (I/F) 16 into which a memory card 8 is insertable is provided. The display device 1 reads a document file or the like stored in the memory card 8 through the memory card I/F 16, and displays the document file or the like on the display part 2.

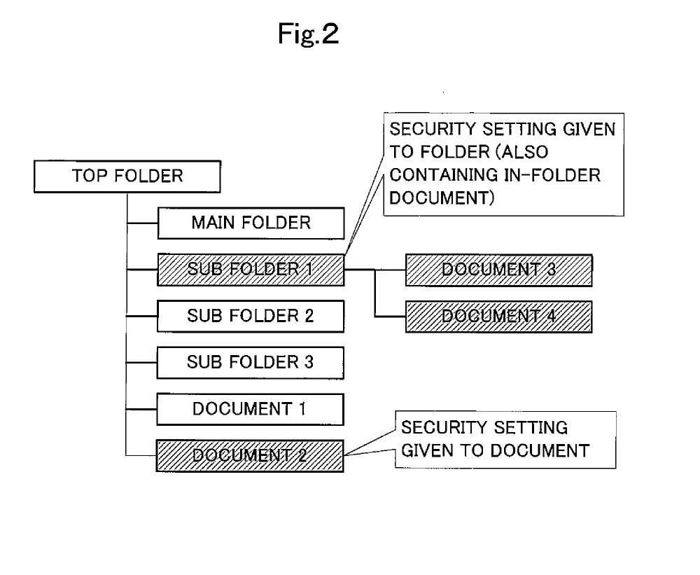

In the memory card 8, for example, document files and information files of folders (hereinafter referred to as “folder files”) arc stored in the hierarchical structure shown in FIG. 2 where a top folder constitutes a vertex. Security setting is given to some document files (documents 2 to 4) and the folder file (sub folder 1).

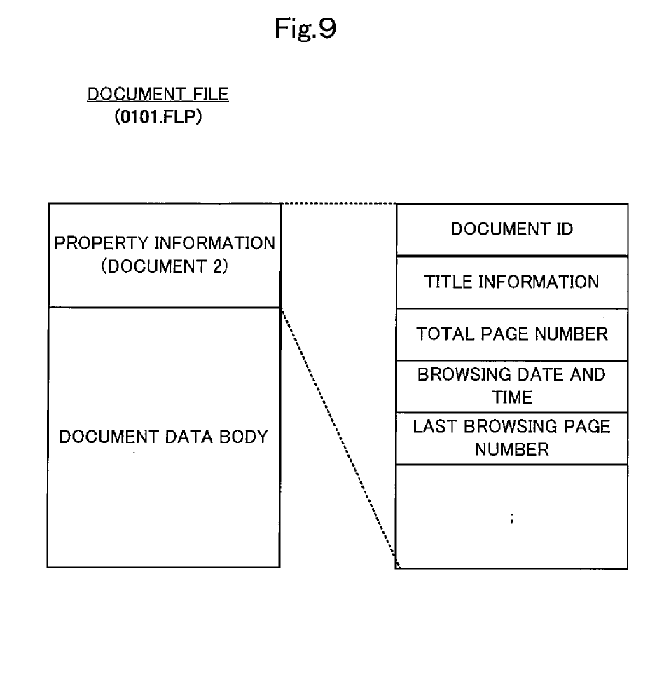

The document file contains, besides a document data body, property information having information such as a document ID which is a file ID and title information (see FIG. 9 described later). The document files to which the security setting is given are encrypted and stored in the memory card 8 except for the document ID. As an encryption method, for example, DES, IDEA or the like can be used. At least the document data body and the title information are separately encrypted and are stored in the memory card 8, and the document data body and the title information can be individually decrypted and read.

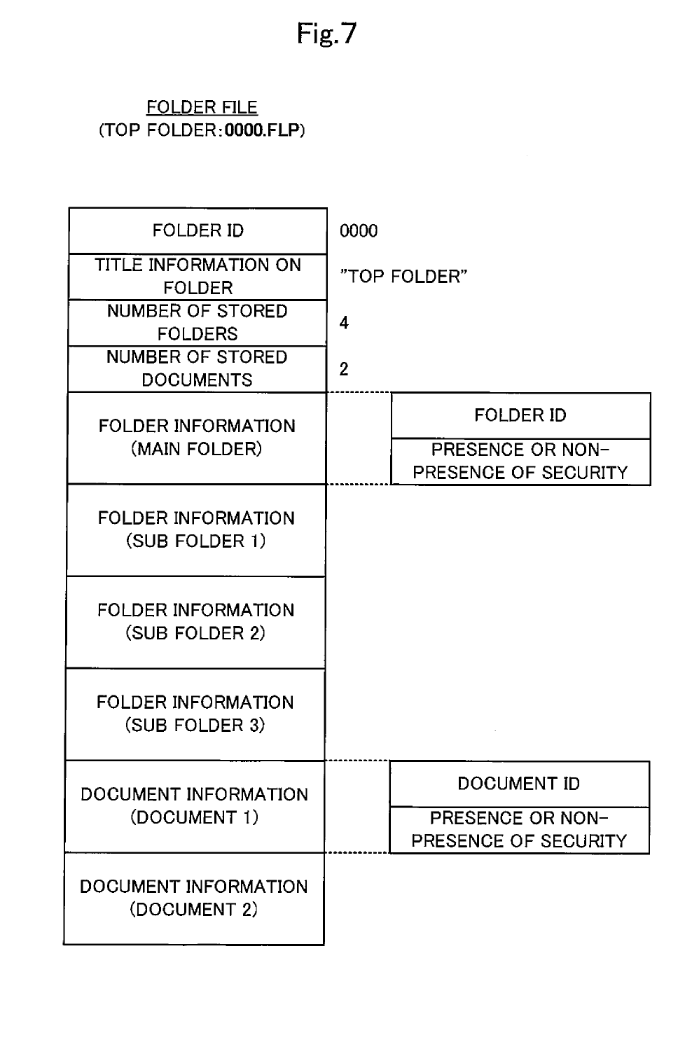

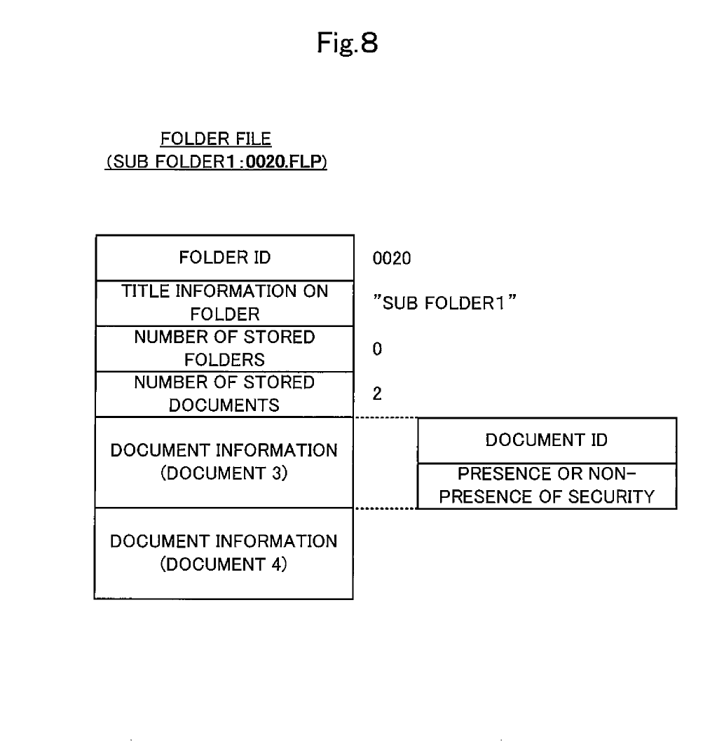

On the other hand, one folder file is provided for every folder. Each folder file contains, besides a folder ID for identifying the folder, a document ID for identifying the document file, a folder ID for identifying the folder file and the like which are contained in the folder. Further, each folder file contains information on the presence or non-presence of security setting (hereinafter referred to as “security setting information”) for every file (see FIG. 7 and FIG. 8 described later).

The folder file, in displaying a title list which is a list of title information on the respective document files and the respective folder files contained in the folder (in-folder title list), functions as list information.

That is, the display device 1 acquires the folder files of the subject folders (top folder or sub folder) which forms the title list as list information from the memory card 8. The display device 1, based on the acquired list information, acquires the title information on the respective document files and/or the folder files in the top folder or the sub folder, forms the title list which is a list of title information on the document files and/or the folder files, and displays the title list on the display part 2.

The display device 1, in forming the title list, acquires title information contained in the document file to which a document ID which agrees with a document ID contained in the folder file of the subject folder is given from the memory card 8. Further, the display device 1 acquires title information contained in the folder file to which a folder ID which agrees with a folder ID contained in the folder file of the subject folder is given from the memory card 8.

Here, in the folder file of the subject folder, the display device 1 does not acquire title information with respect to the document files where security setting information is information indicative of “security setting present”. In the same manner, in the acquired folder file, the display device 1 does not acquire the title information with respect to the folder files where security setting information is information indicative of “security setting present”.

Then, in the display device 1, with respect to the document files and the folder files to which security setting is not given, title information on the document files and the folder files is contained in the title list. On the other hand, in the display device 1, with respect to the document files and the folder files to which security setting is given, the title list is prepared such that predetermined information is contained in the title list. As such predetermined information, for example, a character string such as “security document” or “security folder” is named.

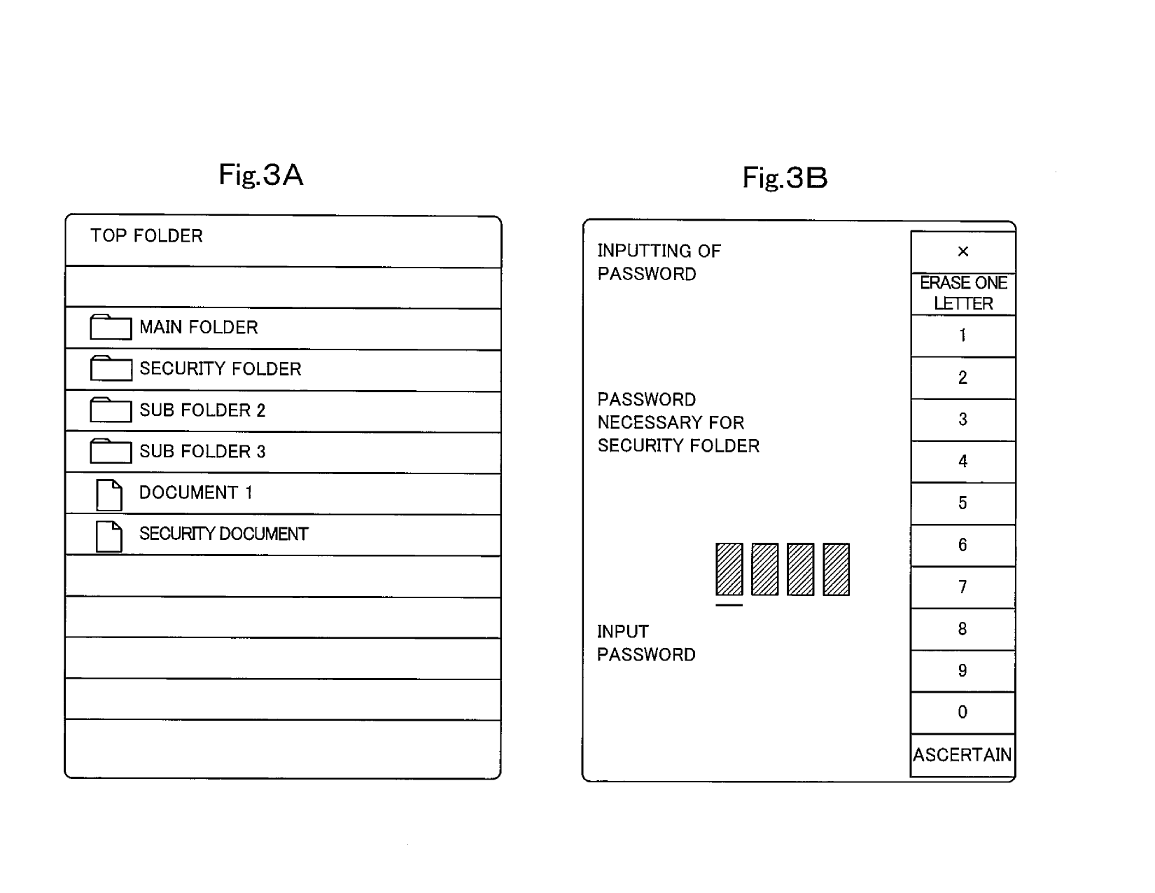

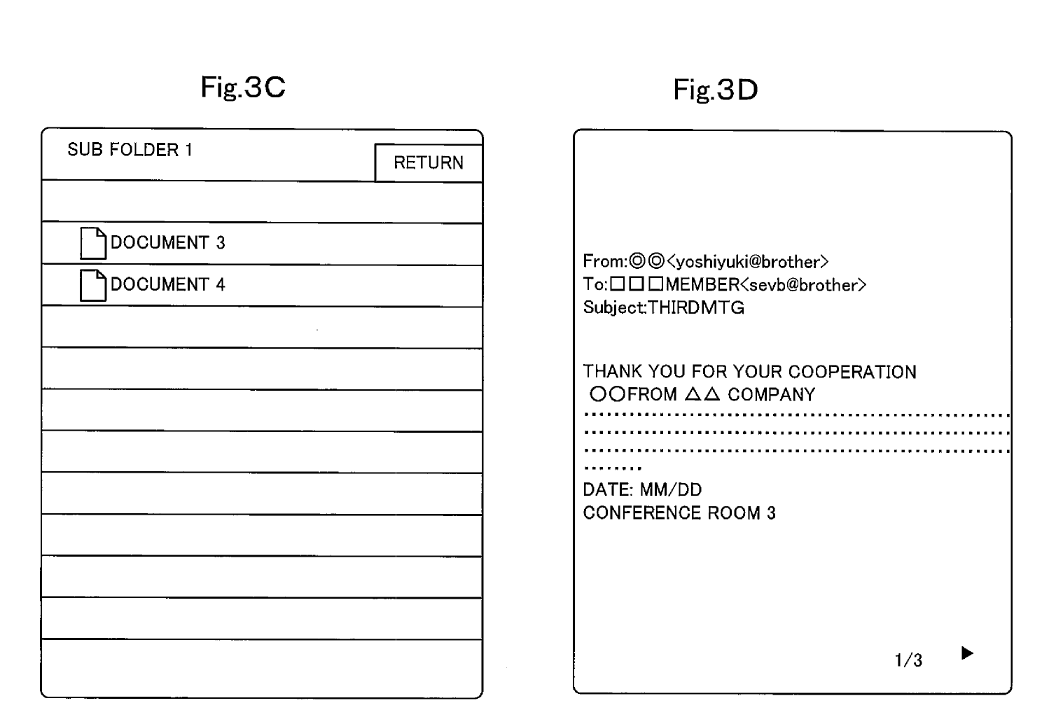

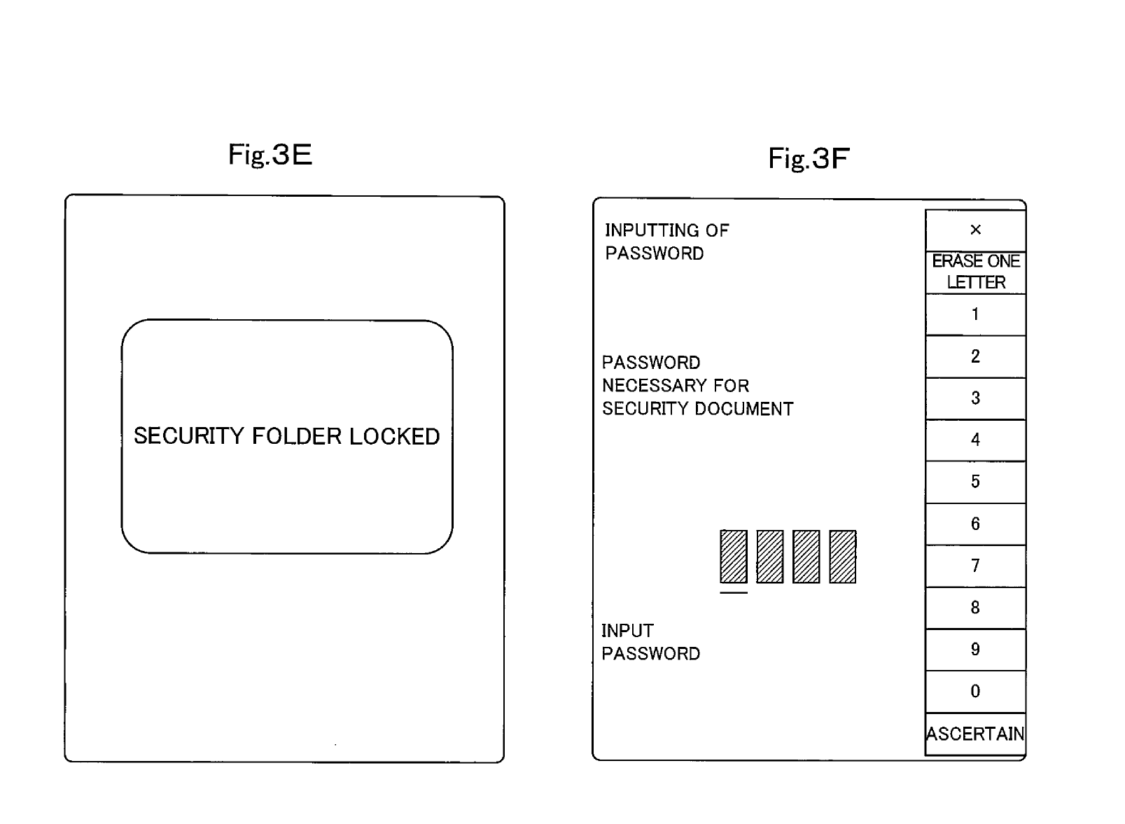

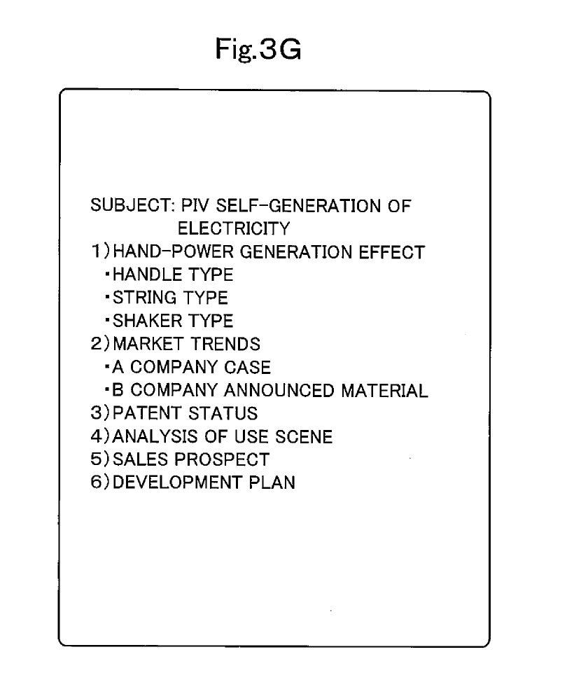

Here, an operation for browsing document files stored in the memory card 8 and processing executed in accordance with such an operation by the display device 1 are explained specifically in conjunction with FIG. 3A to FIG. 3G. This processing is executed by a CPU 10 of the display device 1 described later which constitutes a control part.

To display contents of folder files and/or document files of a top folder or a sub folder, firstly, a user allows the display part 2 to display a menu screen (see FIG. 1) by operating the menu button 5b and, thereafter, the user operates the region selection button 6a.

Due to such an operation, as shown in FIG. 3A, the control part of the display device 1 displays a title list which is a list of title information on the document files and the folder files in the top folder on the display part 2. In this title list, as described above, with respect to the files to which security setting is not given, title information attached to the file is displayed, while with respect to information to which security setting is given, information that security setting is given is displayed as title information. Here, with respect to the document file to which security setting is given, “security document” is displayed as title information, while with respect to the folder file to which security setting is given, “security folder” is displayed as title information.

When “security folder” is selected by operating the region selection button 6, for example, in such a state, the control part of the display device 1, as shown in FIG. 3B, displays a password input screen which prompts a user to input a password as release information for displaying information in the security folder on the display part 2.

When the user inputs the password by operating the region selection button 6 on the screen, the control part of the display device 1 stores the password as a decryption key in a volatile memory (a RAM 12 described later, expressed in the same manner hereinafter) in the display device 1, and tries decryption of at least title information on the folder file which agrees with a folder ID of the folder of the “selected security folder”. In this decryption processing, when the display device 1 succeeds in decrypting and acquires title information or the like of the files (the document files and/or the folder files) contained in the folder file, the control part of the display device 1 displays the title information on these files as a title list on the display part 2 (see FIG. 3C). When the inputted password is wrong, the display of the file is prohibited.

In such a screen, when the user selects a document 3 in the sub folder 1 to which security setting is given by operating the region selection button 6, for example, the control part of the display device 1 decrypts a document data body of the document 3 stored in the memory card 8 using the decryption key stored in the volatile memory, stores the document data body in the volatile memory, and displays the document data body on the display part 2 (see FIG. 3D). Substantially same processing is executed also when the document 4 is selected. When the document data body is formed of data described on a plurality of pages, in the display device 1, it is preferable that the document data body is not collectively encrypted or decrypted. That is, it is preferable that the document data body is encrypted for data of every page, and only data on only pages necessary for display is decrypted. In this manner, by executing decryption processing of only necessary data only when such data is necessary, it is possible to accelerate decryption processing, display processing and the like.

After displaying contents of the documents 3, 4 as shown in FIG. 3D, when the user operates the document closing button 5c, the display returns to assume a state shown in FIG. 3C. When the user operates the region selection button 6a (return button) in a display state shown in FIG. 3C, the display returns to a state where the title list relating to the top folder is displayed on the display part 2 (FIG. 3A). In the transition from the display state shown in FIG. 3C to the display state shown in FIG. 3A, the control part of the display device 1 performs a security lock notification display on the display part 2 for only several seconds thus bringing a security state into a security lock state. The security lock information is the notification which informs a user of the stopping of security release, that is, notification which informs the user that the user cannot browse contents of the folder files or the document files of the sub folder 1 unless the password is inputted again. In this case, the control part of the display device 1 erases the decryption key from the volatile memory in the display device 1 thus bringing the security state into the security lock state.

On the other hand, for example, when “security document” is selected by operating the region selection button 6h in a state where the title list relating to the top folder is displayed on the display part 2 (see FIG. 3A), the control part of the display device 1, as shown in FIG. 3F, displays the password input screen which prompts the user to input a password on the display part 2.

When the user inputs the password by operating the region selection button 6 on the screen, the control part of the display device 1 tries decryption of a document file which agrees with a document ID of the selected “security document” using the password as a decryption key. In this decryption processing, when the display device 1 succeeds in the decryption, the display device 1 stores the decrypted document file in the volatile memory, and displays the decrypted document file on the display part 2 (see FIG. 3G). Here, the control part of the display device 1 brings the security state into a security lock released state, and stores the decryption key in the volatile memory installed in the display device 1. On the other and, in the decryption processing of the document file corresponding to “security document”, when the control part of the display device 1 does not succeed in decryption and cannot acquire the document data body and the like, the control part of the display device 1 performs a display which informs the user that the inputted password is wrong on the display part 2. When the password inputted in this manner is wrong, the display of the document file is prohibited. When the document data body is formed of data described on a plurality of pages, in the control part of the display device 1, it is preferable that the document data body is not collectively encrypted or decrypted. That is, it is preferable that the document data body is encrypted for data of every page and only data on only pages necessary for display is decrypted.

After displaying contents of the document 2 as shown in FIG. 3G, when the user operates the region selection button 6a (return button), the display returns to a state where the title list relating to the top folder is displayed on the display part 2 (see FIG. 3A). In the transition from the display state shown in FIG. 3G to the display state shown in FIG. 3A, the control part of the display device 1 performs a display of security lock notification on the display part 2 for only several seconds thus bringing a security state to a security lock state. Further, in this step, the control part of the display device 1 erases the decryption key from the volatile memory in the display device 1 and brings the security state into a security lock state.

In this manner, according to the display device 1 of this embodiment, in displaying the title list which is a list of title information on the document files or the folder files in each folder (top folder or sub folders) on the display part 2, predetermined information is displayed in the title list in place of title information relating to the document file or the folder file to which security setting is given. Accordingly, it is possible to ensure confidentiality of data file when the title list is displayed.

In the above-mentioned display device 1, the folder file contains the file ID (document ID or folder ID) for acquiring title information on respective files, and the title information is acquired from the document files or the folder files based on the file IDs. However, the folder file may directly contain title information on the respective files.

Further, in the above-mentioned display device 1, the folder file contains security setting information on the respective files, and it is determined whether or not security setting is given to the document file or the folder file based on the security setting information. However, the method of determining whether or not security setting is given to the files is not limited to such determination. For example, in the display device 1, the folder file may not contain security setting information. That is, a security setting file which is associated with security setting information for every file ID (document ID or file ID) may be provided additionally, and security setting information corresponding to the file ID may be acquired from the security setting file. In this case, list information is constituted of the folder file and a security setting file.

The explanation has been made heretofore with respect to the operation when the title list which is a list of title information on the document file or the folder file in each folder is displayed on the display part 2. According to the display device 1 of this embodiment, also in displaying contents of a browsing history file as list information, with respect to document files to which security setting is given in the same manner, predetermined information is displayed in the title list in place of title information on the document files.

That is, the control part of the display device 1, for example, when contents of the document files are displayed on the display part 2, as shown in FIG. 3D and FIG. 3G; stores the display history of the contents as browsing history files in the volatile memory in the display device 1. Then, the control part of the display device 1 displays the browsing history files stored in the volatile memory in the display device 1 on the display part 2 as list information. The browsing history title list is a title list which is a list of title information on browsed document files.

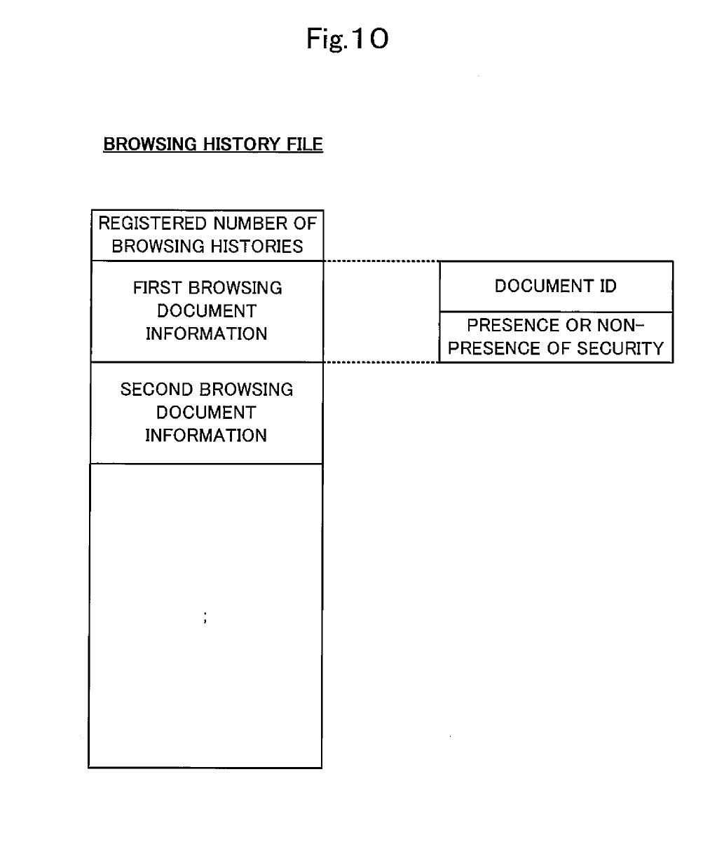

The browsing history file contains document IDs and security setting information for the respective document files which are browsed by the user (see FIG. 10 described later). The control part of the display device 1 determines that security setting is given to the document files when the security setting information is information indicative of “security setting present”, and does not allow a user to acquire title information on the document files. On the other hand, when the security setting information is information indicative of “security setting not present”, the control part of the display device 1 determines that the security setting is not given to the document file, and allows the user to acquire the title information on the document file from the document files which agree with document IDs stored in the memory card 8.

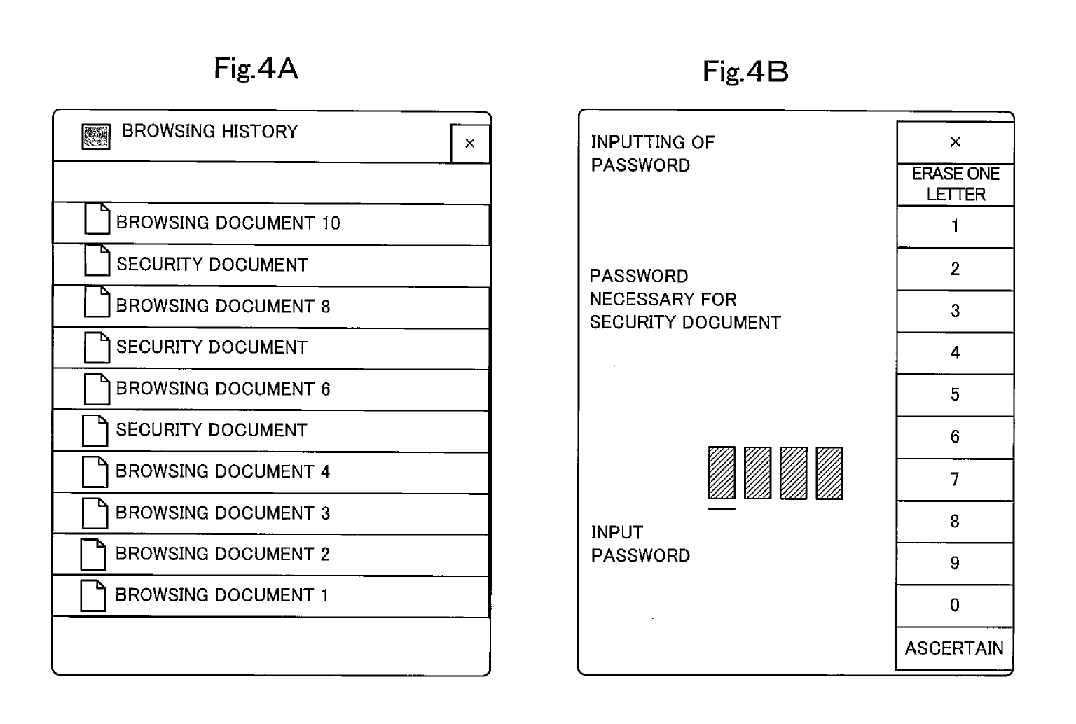

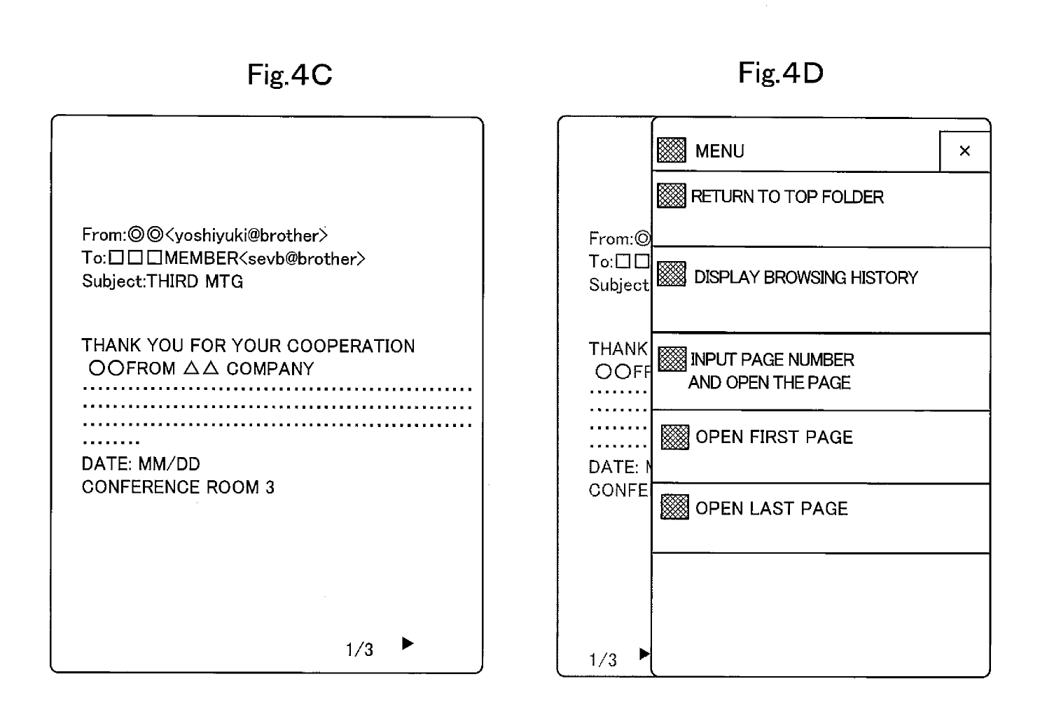

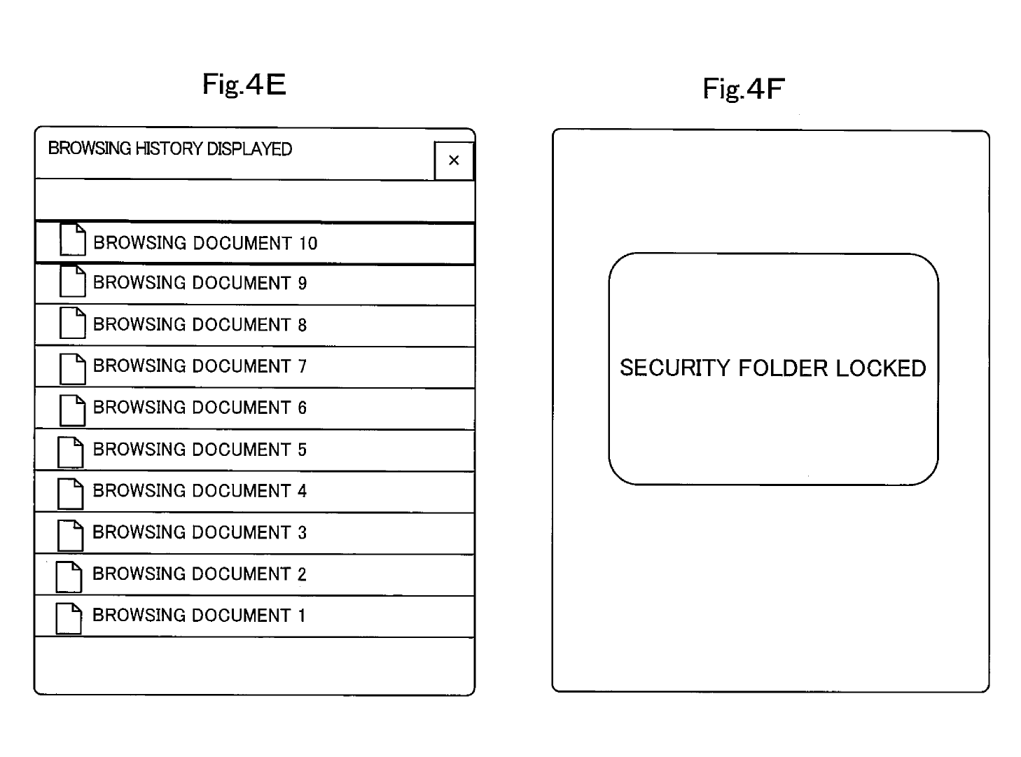

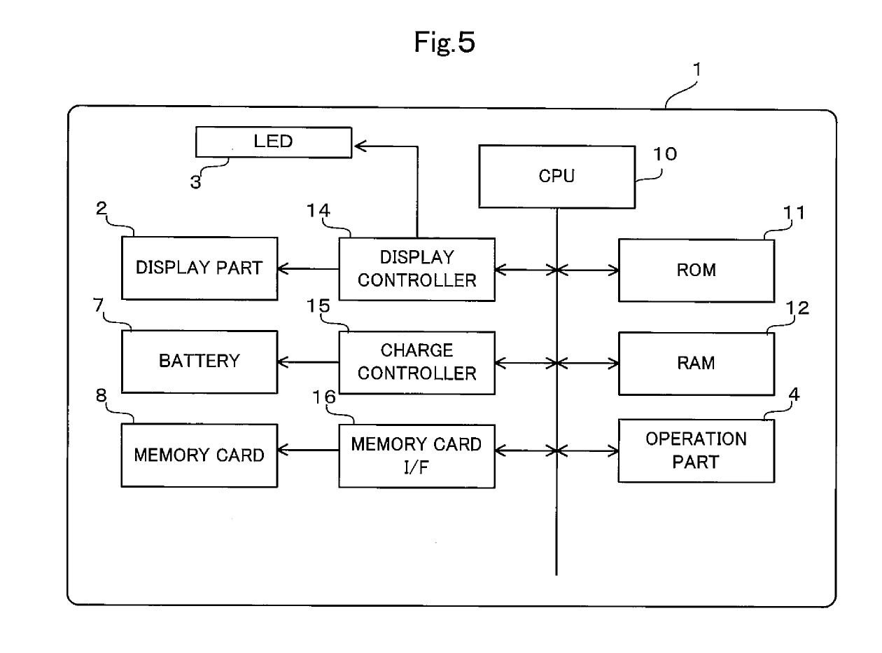

Here, an operation for displaying contents of a browsing history file and processing executed by such an operation in the display device 1 are explained specifically in conjunction with FIG. 4A to FIG. 4F. This processing is executed by the CPU 10 of the display device 1 described later which constitutes the control part.

To display a content of the browsing history file on the display part 2, firstly, a user operates the menu button 5b so that a menu screen (see FIG. 1) appears on the display part 2. Then, the user operates the region selection button 6b.

Due to such operations, as shown in FIG. 4A, the control part of the display device 1 displays a title list which is a list of title information on the document files whose document IDs are contained in the browsing history file. Here, with respect to the document files to which security setting is given, the control part of the display device 1 forms the title list such that the predetermined title information (here, character string of “security document”) is contained in the title list and displays the title list on the display part 2. On the other hand, with respect to the document file to which security setting is not given, the control part of the display device 1 forms the title list such that the unique title information is contained in the document and displays the title list on the display part 2.

In such a state, for example, when the user selects “security document” by operating the region selection button 6, the control part of the display device 1, as shown in FIG. 4B, displays the password input screen which prompts the user to input a password on the display part 2. The password is release information for displaying information on the security document.

When the user inputs the password by operating the region selection button 6 on the screen, the control part of the display device 1 tries the decryption of a document file which agrees with a document ID of the selected “security document” using the password as a decryption key. In this decryption processing, the control part of the display device 1, when the display device 1 succeeds in the decryption, stores the decrypted document file in the volatile memory, and displays the decrypted document file on the display part 2 (see FIG. 4C). Here, the control part of the display device 1 brings the security state into a security lock released state, and stores the decryption key in the volatile memory installed in the display device 1. On the other hand, in the decryption processing of the document file corresponding to “security document”, when the control part of the display device 1 does not succeed in decryption and cannot acquire the document data body and the like, the control part of the display device 1 performs a display which informs the user that the inputted password is wrong on the display part 2. When the document data body is formed of data described on a plurality of pages, in the control part of the display device 1, it is preferable that the document data body is not collectively encrypted or decrypted but is encrypted for data of each page and data on the pages necessary for display is decrypted.

After displaying contents of the document 2 as shown in FIG. 4C, when the user operates the menu button 5b (see FIG. 4D) and, thereafter, operates the region selection button 6c, the display returns to a state where the title list which is a list of title information on the document file whose document ID is contained in the browsing history file is displayed on the display part 2 (see FIG. 4E). Here, the security state assumes a security lock released state and hence, the control part of the display device 1, as shown in FIG. 4E, displays the title list which enumerates the titles of the document files whose document IDs are contained in the browsing history file on the display part 2.

Thereafter, when the user selects browsing of the document files to which security setting is not given by operating the operation part 4, the control part of the display device 1 performs the display of security lock notification on the display part 2 only for several seconds, and displays contents of the selected document file on the display part 2. Here, the control part of the display device 1 erases the decryption key from the volatile memory in the display device 1, and brings the security state into a security lock state. The security lock notification is notification that security release is stopped, that is, notification that out of the document files having document IDs contained in the browsing history file, the user cannot browse the content of the document files to which security setting is given unless the password is inputted again.

In this manner, according to the display device 1 of this embodiment, in displaying the title list which is a list of titles of the document files having browsing history on the display part 2, the predetermined information is displayed in the title list in place of title information on the document files to which security setting is given. Accordingly, it is possible to ensure confidentiality of the data files when the title list is displayed.

In the above-mentioned display device 1, the browsing history file contains the document ID for acquiring title information on the document files, and the title information is acquired from the document files based on the document IDs. However, the browsing history file may contain title information on the document file.

Further, in the above-mentioned display device 1, the browsing history file contains security setting information on the respective document files, and it is determined whether or not security setting is given to the document files based on the security setting information. However, the method of determining whether or not security setting is given is not limited to such determination. For example, in the display device 1, the browsing history file may not contain security setting information. That is, a security setting files which are associated with security setting information for the respective document IDs may be provided additionally, and security setting information corresponding to the document IDs may be acquired from the security setting files. In this case, list information is constituted of the browsing history file and the security setting files.

### [2. Specific Constitution of Display Device]

Next, the constitution and the manner of operation of the above-mentioned display device 1 is specifically explained by taking an example of the specific constitution of the display device 1.

### [2.1 Overall Constitution of Display Device]

The electrical constitution of the display device 1 is explained in conjunction with FIG. 5.

As shown in FIG. 5, the display device 1 includes the display part 2, the LED 3, the operation part 4, a battery 7, the memory card 8, the CPU10, a ROM 11, the RAM 12, a display controller 14, a charge controller 15, and the memory card I/F 16.

Various information and a program which operates the display device 1 are stored in the ROM 11. The CPU 10 functions as the control part described above, by reading the program from the ROM 11 and executing the program, and is operated as an information acquisition unit, a display control unit and the like. In this manner, the CPU 10 performs a total control of the display device 1. The RAM 12 is a memory which temporarily stores various data (for example, decrypted document file and folder file) and is used in the control processing executed by the CPU 10. In place of preliminarily storing the program in the ROM 11, the CPU 10 of the display device 1 may take out the program from a storage medium such as the memory card 8 through the memory card I/F 16 and may store the program in the ROM 11. In this case, the program is stored in the memory card 8. A flash memory or the like is used as the ROM 11.

The display controller 14 controls display contents to be displayed on the display part 2 and display contents to be displayed on the LED 3. For example, when the display part 2 is the above-mentioned electrophoresis display panel, the display controller 14 includes an FPGA (Field Programmable Gate Array), a power source generating part (DC-DC converter or the like) and the like. Here, the FPGA controls a gate driver and a source driver described later which operate TFTs by which voltages are given to pixel electrodes of the display panel. The power source generating part generates power necessary for driving the display panel.

The display device 1 is, when power is not supplied thereto from an external power source not shown in the drawing, driven by power from the battery 7. As a power supply path from the battery 7 or the external power source, two paths are provided. That is, the power supply path is constituted of one path through which power is supplied to the CPU 10, and the other path through which power is supplied to peripheral devices such as the ROM 11, the RAM 12 and the display controller 14. The charge controller 15 controls charging of power to the battery 7 from the external power source.

Various information is written in the memory card 8 using a dedicated software or the like installed in a personal computer (hereinafter referred to as “PC”) not shown in the drawing. The memory card I/F 16 controls reading of information from the memory card 8 and writing of information into the memory card 8. The CPU 10, by controlling the memory card I/F 16, reads information such as the document files, the folder files or the like from the memory card 8 and writes browsing history information into the memory card 8.

In this embodiment, the explanation is made hereinafter by assuming that the folder files (folder files such as a top folder, main folder and sub folders), the document files and the browsing history file are preliminarily stored in the memory card 8. The folder files and the document files are stored in the memory card 8 from the PC through a memory card I/F (not shown in the drawing) connected to the PC. The browsing history file is stored in the memory card 8 by the display device 1 through the memory card I/F 16.

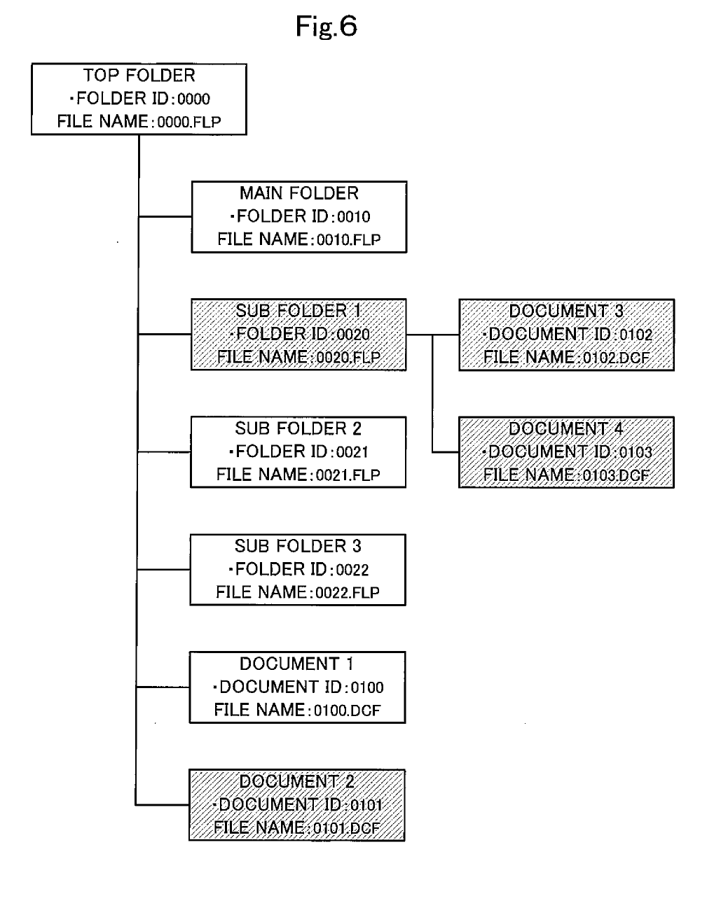

The explanation is made hereinafter by assuming that various folder files (top folder, main folder, sub folders 1 to 3) and document files (documents 1 to 4) having the hierarchical structure shown in FIG. 6 are stored in the memory card 8.

The folder file contains, as shown in FIG. 7 and FIG. 8, the folder IDs of the folders, the title information on the folders, information on the number of stored folders, information on the number of stored documents, folder information, document information and the like. The folder information contains the folder IDs and security setting information. The document information contains the document IDs and security setting information.

The folder file shown in FIG. 7 is the top folder file. “Top folder” is set in the top folder file as the title information on the top folder file. The number of stored folders is “4” and the number of stored documents is “2” and hence, the top folder file contains 4 folder information and 2 document information. Further, the folder file shown in FIG. 8 is the sub folder file corresponding to the sub folder 1. “Sub folder 1” is set in the sub folder file as the title information on the sub folder file. The number of stored folders is “0” and the number of stored documents is “2” and hence, the sub folder file contains 2 document information.

The document file contains, as shown in FIG. 9, property information and a document data body. The document data body is data itself which is displayed on the display part 2. The document data body contains data on respective pages of the document to be displayed on the display part 2. Further, property information contains information such as the document ID, title information, total number of pages of the document, browsing date (date and time that data is displayed on the display part 2), and the final browsing page number (page number displayed on the display part 2 last).

The browsing history file contains, as shown in FIG. 10, the number of registered browsing histories and the browsing document information. The browsing document information contains the document IDs of the browsed document files (hereinafter also referred to as “browsing documents”) and security setting information.

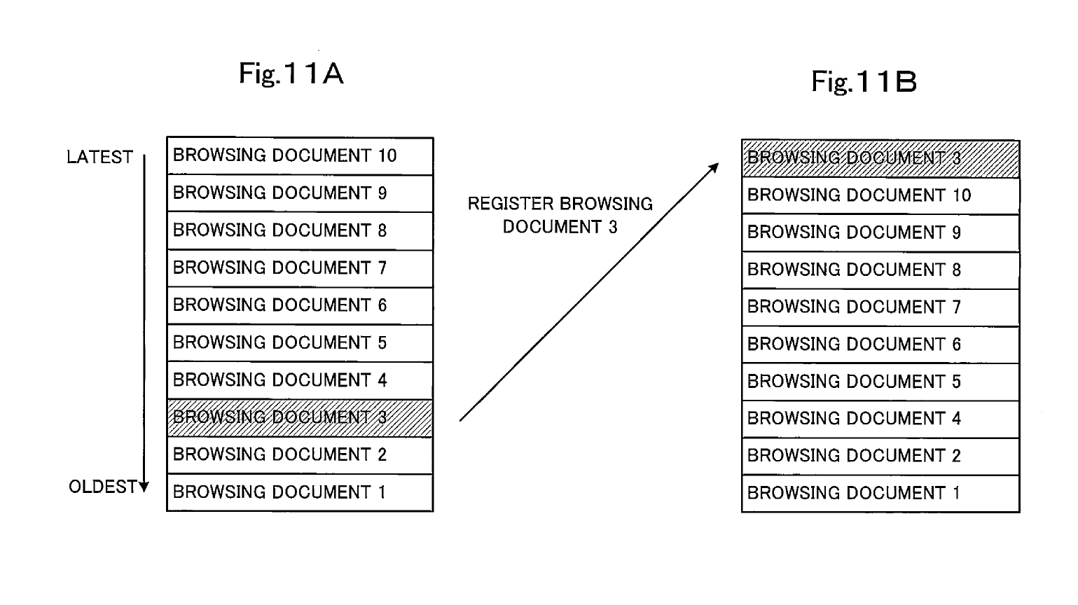

The browsing history file is updated every time the document file is displayed on the display part 2, and is arranged in order such that the browsing document information relating to the document file displayed last comes first in the arrangement. For example, when a user browses the document 3, for example, in a state where the browsing document information is arranged in the order shown in FIG. 11A, as shown in FIG. 11B, the browsing history file is rearranged such that the browsing document information which contains the document ID or the like of the document 3 becomes the latest browsing document information. That is, there is no case where two or more same document information are stored in the browsing history file.

Although the explanation has been made assuming that the folder files and the document files are formed by the PC, these files may be formed within the display device 1.

### [2.2 Specific Operations of Display Device 1]

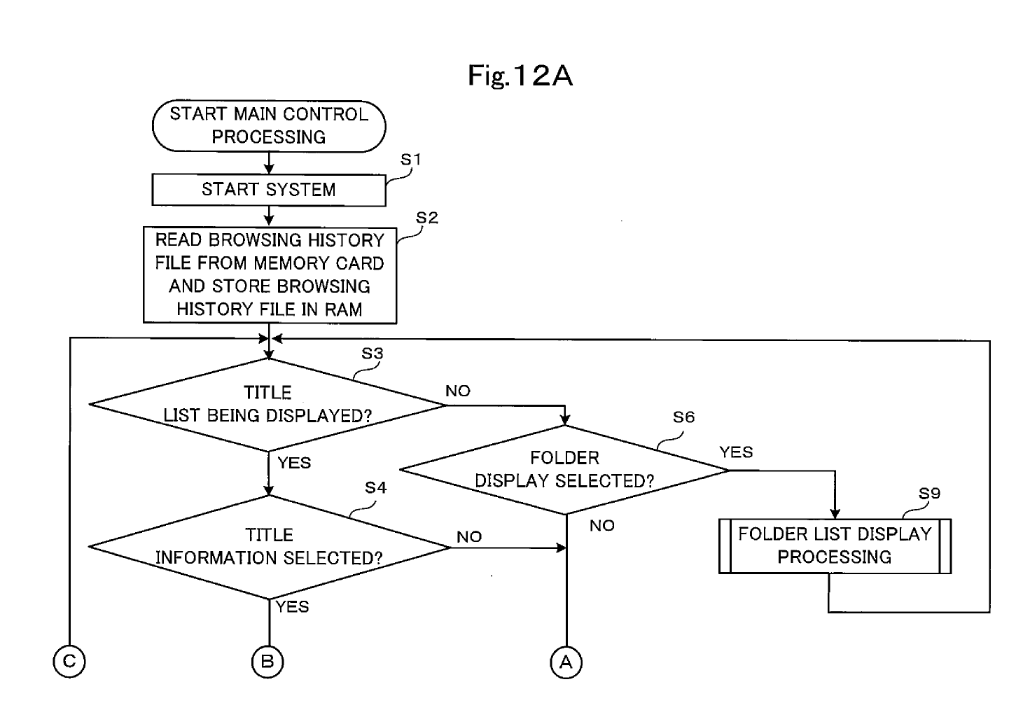

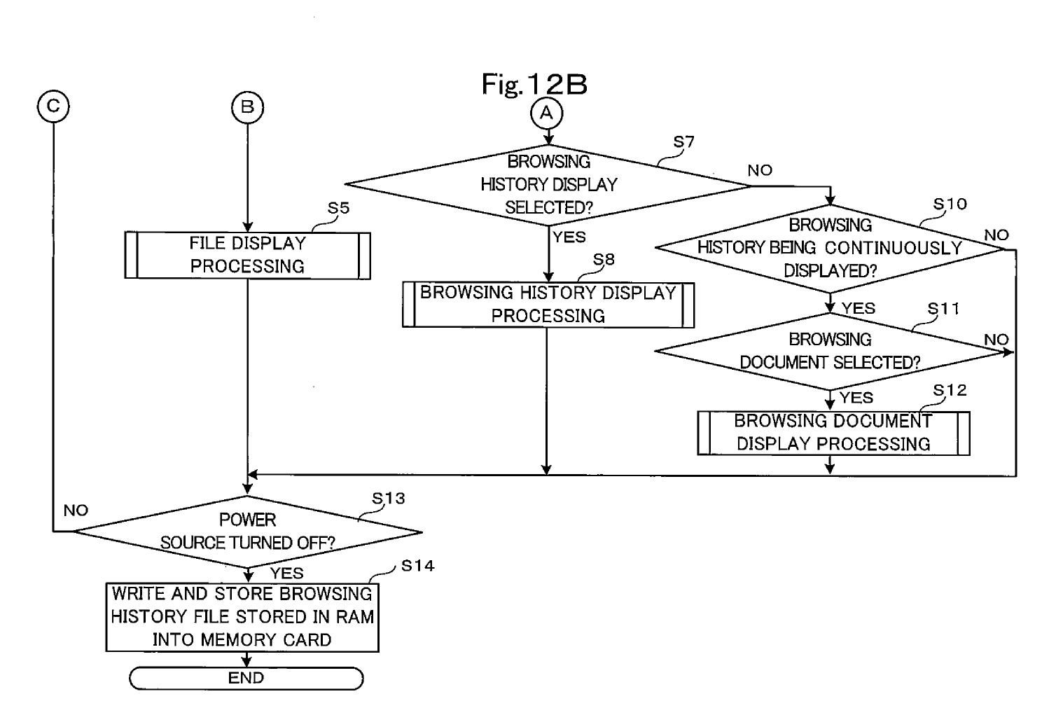

Next, the specific operations of the display device of this embodiment are explained in conjunction with FIG. 12A to FIG. 16B. Processing relating to the title list is mainly explained hereinafter, and the explanation of other processing is omitted here. FIG. 12A to 12C is a flowchart showing a flow of main control processing executed by the display part 2. The main control processing is processing which starts when a user operates the power source button 5a.

As shown in FIG. 12A, the CPU 10 of the display device 1, when the main control processing starts, executes the starting processing of the display device 1 (step S1). In this starting processing, the RAM 12 and the like are initialized, and a program is read from the ROM 11 so that the CPU 10 is brought into a program executable state. That is, the CPU 10 is brought into a state where the CPU 10 functions as the above-mentioned information acquisition unit, the display control unit and the like.

Next, the CPU 10 functions as the information acquisition unit, and reads the browsing history file from the memory card 8 through the memory card I/F 16 and stores the browsing history file in the RAM 12 (step S2). When the browsing history file is not stored in the memory card 8, the CPU 10 stores the default browsing history file (the file in which the number of registered browsing histories is set to “0”) which is preliminarily stored in the ROM 11.

Then, the CPU 10 determines whether or not the title list which is a list of title information on the document files and the folder files contained in the folder is displayed on the display part 2 (step S3). In this processing, when the CPU 10 determines that the title list is displayed on the display part 2 (step S3: YES), the CPU 10 advances the processing to step S4. On the other hand, when the CPU 10 determines that the title list is not displayed on the display part 2 (step S3: NO), the CPU 10 advances the processing to step S6.

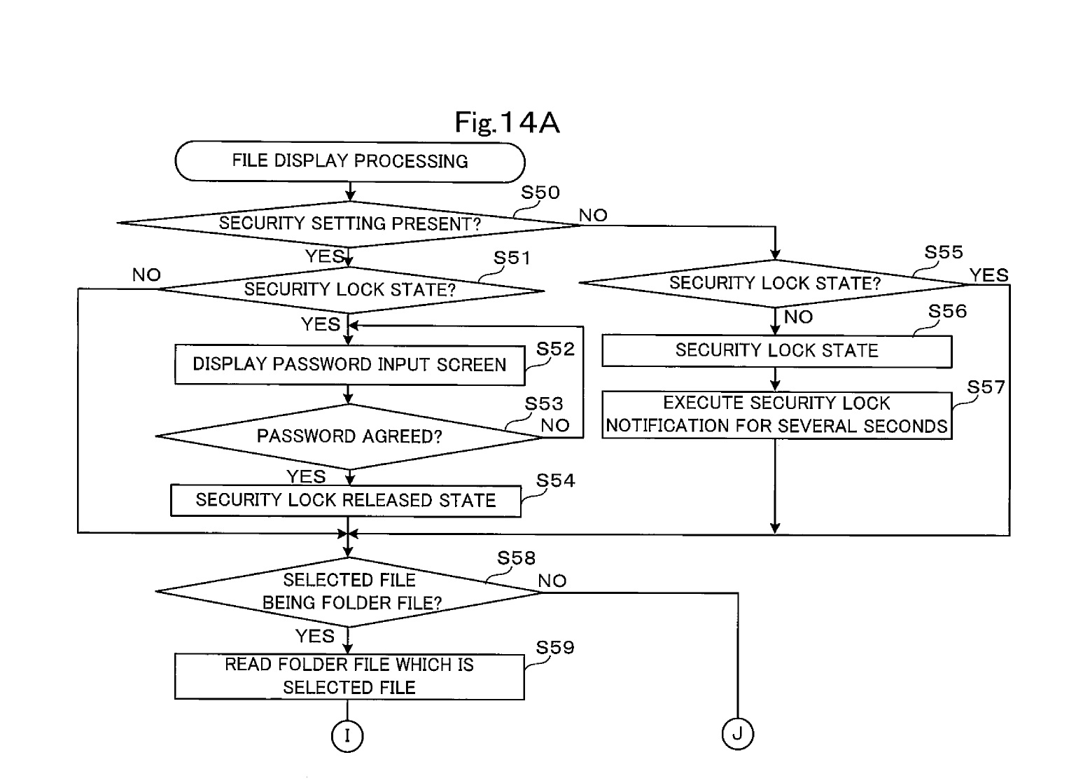

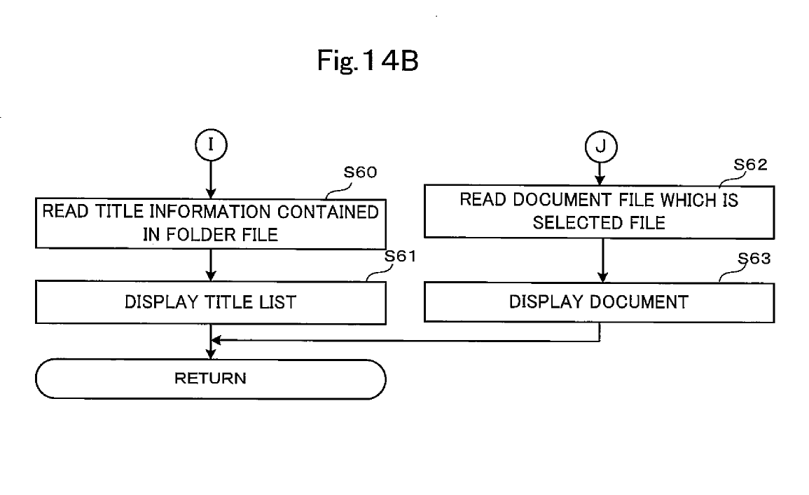

In step S4, the CPU 10 determines whether or not the title information on the title list displayed on the display part 2 is selected due to an operation of the region selection button 6 by the user. In this processing, when the CPU 10 determines that the title information is selected (step S4: YES),as shown in FIG. 12B, the CPU 10 executes file display processing (step S5). This “file display processing” is processing executed in steps S50 to S63 shown in FIG. 14A and FIG. 14B and is described in detail later. On the other hand, when the CPU 10 determines that the title information is not selected (step S4: NO), the CPU 10 advances the processing to step S7 described later.

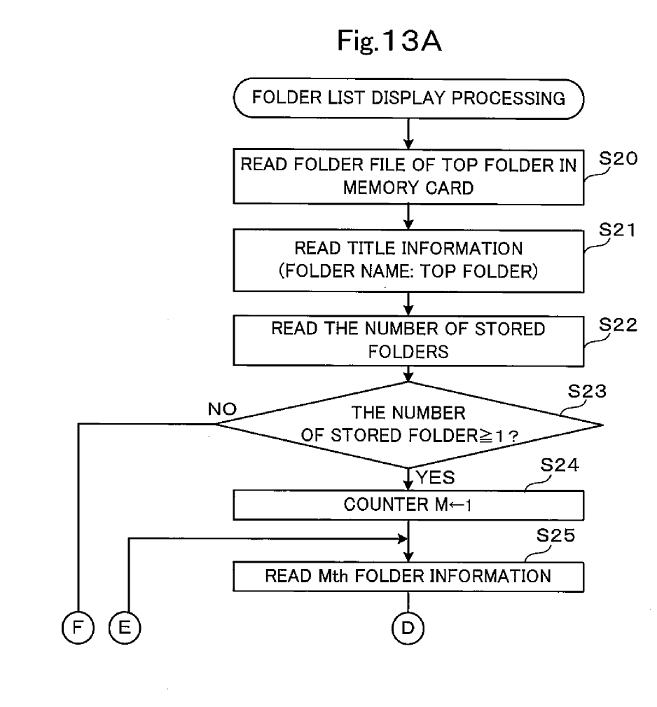

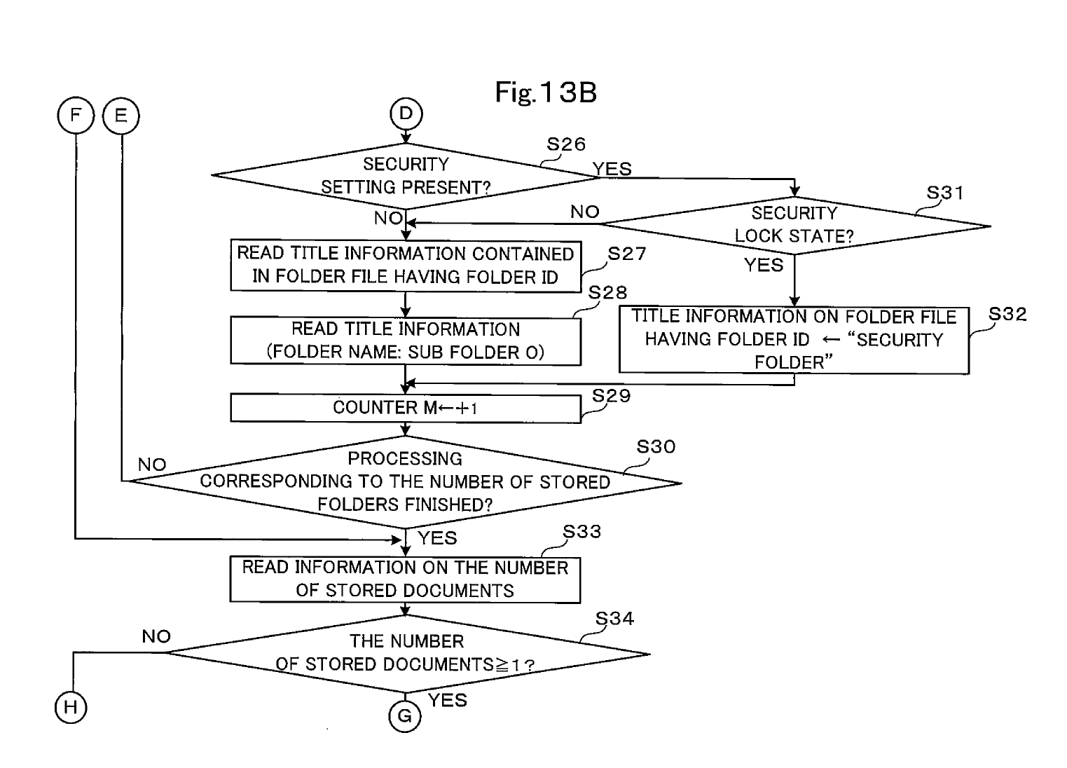

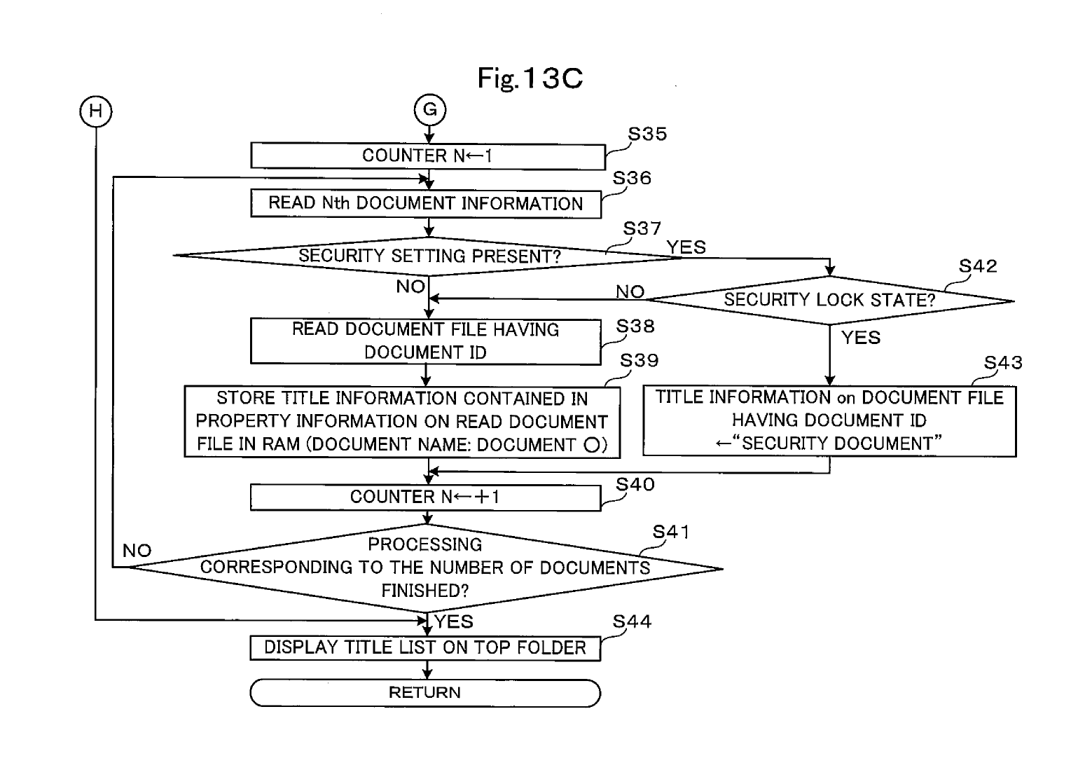

Further, In step S6, the CPU 10 determines whether or not the folder display selection is made. To be more specific, when the selection which allows the display part 2 to display contents of the top folder is made due to an operation of the menu button 5b, the region selection button 6 or the like by the user, the CPU 10 determines that the folder display selection is made. In this processing, when the CPU 10 determines that the folder display selection is made (step S6: YES), the CPU 10 executes list display processing of the folder (step S9). This “list display processing of folder” is processing in steps S20 to S44 shown in FIG. 13A to FIG. 13C and is described in detail later. On the other hand, when the CPU 10 determines that the folder display selection is not made (step S6: NO), the CPU 10 advances the processing to step S7.

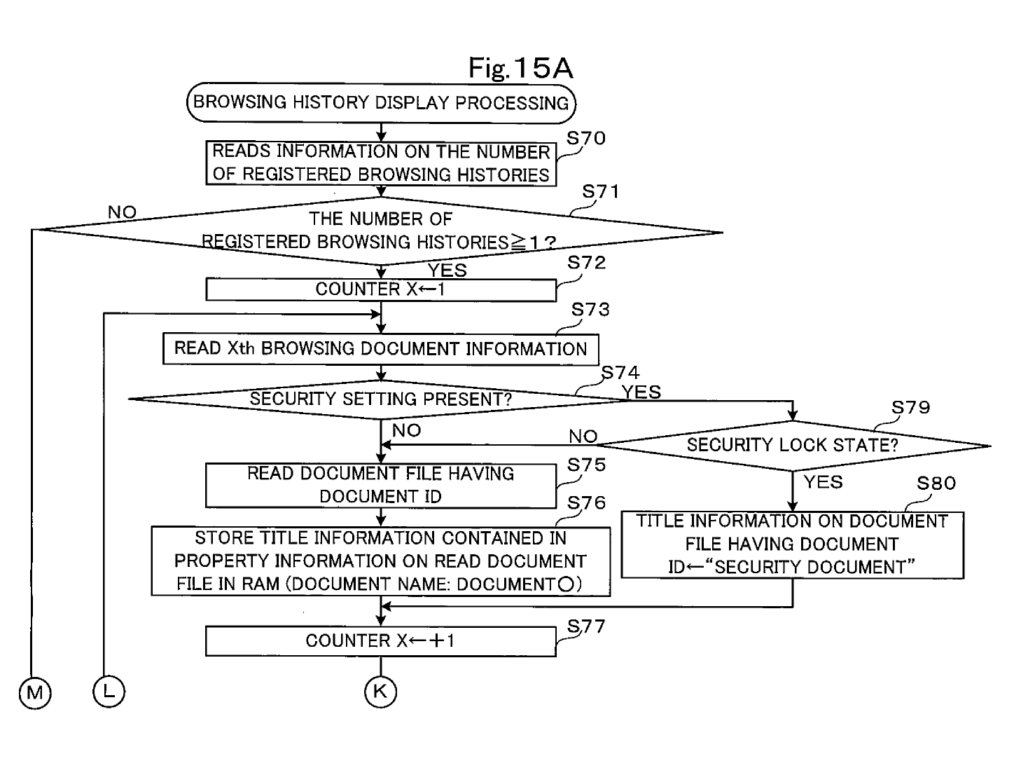

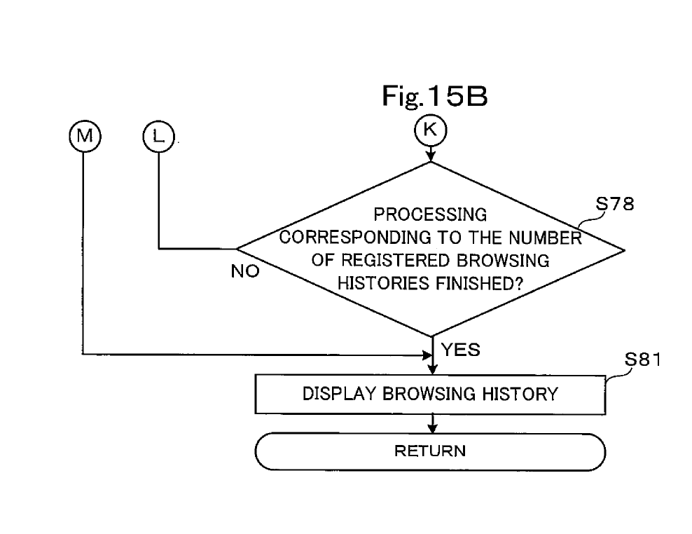

In step S7, the CPU 10 determines whether or not browsing history display selection is made. To be more specific, when the selection of allowing the display part 2 to display contents of the browsing history file is made due to an operation of the menu button 5b, the region selection button 6 or the like by the user, the CPU 10 determines that the browsing history display selection is made. In this processing, when the CPU 10 determines that the browsing history display selection is made (step S7: YES), the CPU 10 executes browsing history display processing (step S8). This browsing history display processing is processing in steps S70 to S81 shown in FIG. 15A to 15B and is described in detail later. On the other hand, when the CPU 10 determines that the browsing history display selection is not made (step S7: NO), the CPU 10 advances the processing to step S10.

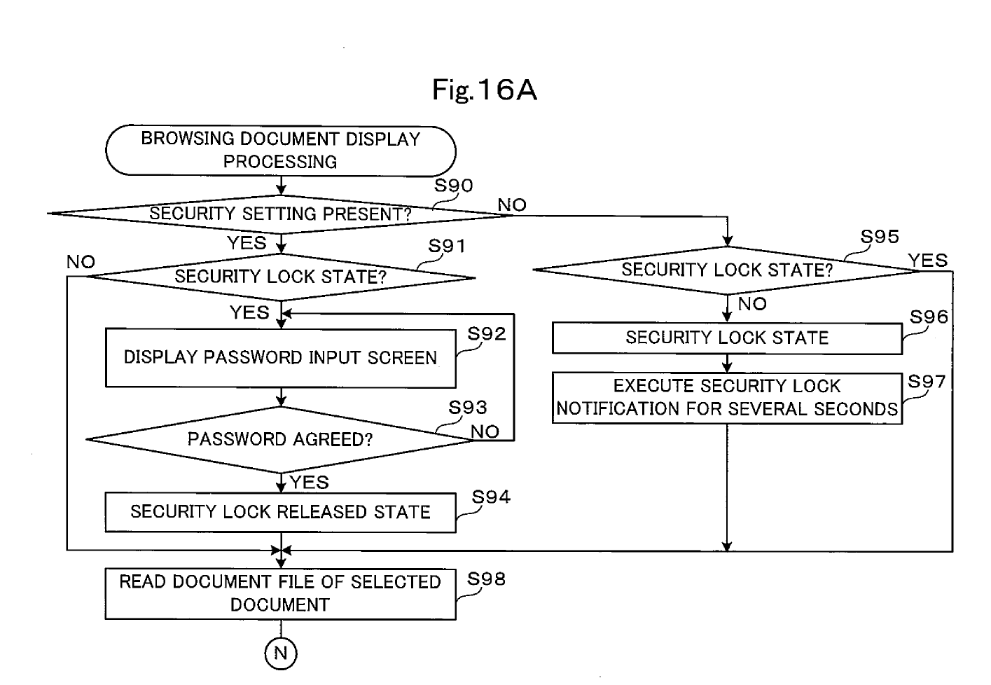

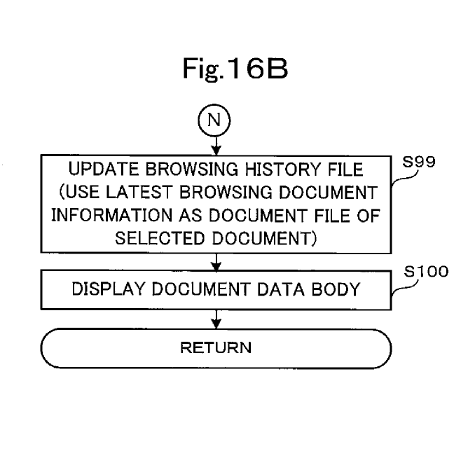

In step S10, the CPU 10 determines whether or not browsing history is continuously displayed. That is, the CPU 10 determines whether or not contents of the browsing history file are in a state where the contents of the browsing history file are displayed on the display part 2. In this processing, when the CPU 10 determines that the browsing history is continuously displayed (step S10: YES), the CPU 10 determines whether or not the browsing document is selected (step S11). To be more specific, when any one of the document files whose title information is displayed on the display part 2 is selected as the document file having the browsing history due to an operation of the region selection button 6 or the like by the user, the CPU 10 determines that the browsing document is selected. In this processing, when the CPU 10 determines that the browsing document is selected (step S11: YES), the CPU 10 executes the browsing document display processing (step S12). The browsing document display processing is processing in steps S90 to S100 shown in FIG. 16A and FIG. 16B and is described in detail later. On the other hand, when the CPU 10 determines that the browsing document is not selected (step S11: NO), the CPU 10 advances the processing to step S13.

In step S13, the CPU 10 determines whether or not the power source of the display device 1 is to be turned off. For example, when a state where the operation part 4 of the display device 1 is not operated continues for a predetermined time (for example, 3 minutes) or the power source button 5a is operated, the CPU 10 determines that power source of the display device 1 is to be turned off. When the CPU 10 determines that the power source of the display device 1 is to be turned off (step S13: YES), the CPU 10 writes and stores the browsing history file stored in the RAM 12 into the memory card 8 (step S14). Here, when the browsing history file is stored in the memory card 8, the browsing history file is erased, and the browsing history file stored in the RAM 12 is written in the memory card 8. On the other hand, when the CPU 10 determines that the power source of the display device 1 is not to be turned off (step S13: NO), the CPU 10 returns processing to step S3.

Next, “folder list display processing” in step S9 is explained in conjunction with FIG. 13A to FIG. 13C.

As shown in FIG. 13A, when this processing starts, the CPU 10 functions as the information acquisition unit. The CPU 10 reads the folder file of the top folder stored in the memory card 8 through the memory card I/F 16, and stores the folder file of the top folder in a predetermined region of the RAM 12 (step S20). Here, a file name “0000. FLP” is given to the folder file of the top folder, and the CPU 10 detects the folder file of the top folder based on this file name, and reads the folder file of the top folder.

Next, the CPU 10 reads title information from the folder file of the top folder (step S21). Here, the folder file of the top folder includes a character string “top folder” as title information (see FIG. 7).

Next, the CPU 10 reads information on the number of stored folders from the folder file of the top folder (step S22), and determines whether or not the number of stored folders is “1” or more (step S23). When the CPU 10 determines that the number of stored folders is “1” or more(step S23: YES), the CPU 10 sets a count value M of a counter to “1” (step S24). Thereafter, the CPU 10 reads the Mth folder information out of the folder information contained in the folder file of the top folder (step S25). Next, as shown in FIG. 13B, the CPU 10 determines whether or not security setting information contained in this folder information is information indicative of “security setting present” (step S26). In this processing, when the CPU 10 determines that security setting information contained in this folder information is information indicative of “security setting present” (step S26: YES), the CPU 10 advances the processing to step S31. On the other hand, when the CPU 10 determines that security setting information contained in this folder information is not information indicative of “security setting present” but is information indicative of “security setting not present” (step S26: NO), the CPU 10 advances the processing to step S27.

In step S27, the CPU 10 reads the title information contained in the folder file having a folder ID which agrees with a folder ID contained in the Mth folder information from the memory card 8. The CPU 10 stores the title information in a title list region of the RAM 12 as title list information (step S28), and adds “1” to the count value M of the counter (step S29).

Further, in step S31, the CPU 10 determines whether or not a security state of the display device 1 is a security lock state. In this processing, when the CPU 10 determines that the security state of the display device 1 is not a security lock state (step S31: NO), the CPU 10 advances the processing to step S27. On the other hand, when the CPU 10 determines that the security state of the display device 1 is a security lock state (step S31: YES), the CPU 10 reads predetermined information (character string “security folder”) stored in the ROM 11 as the title information on the folder file having the folder ID which agrees with the folder ID contained in the Mth folder information. The CPU 10 stores the predetermined information in the title list region of the RAM 12 as title list information (step S32), and advances the processing to step S29.

When the processing in step S29 is finished, the CPU 10 determines whether or not processing corresponding to the number of stored folders is finished (step S30). When the count value M of the counter becomes equal to the number of stored folders, the CPU 10 determines that processing corresponding to the number of stored folders is finished. In this processing, when the CPU 10 determines that processing corresponding to the number of stored folders is not finished (step S30: NO), the CPU 10 returns the processing to step S25. On the other hand, when the CPU 10 determines that processing corresponding to the number of stored folders is finished (step S30: YES), the CPU 10 advances the processing to step S33.

In step S33, the CPU 10 reads information on the number of stored documents from the folder file of the top folder, and determines whether or not the number of stored documents is “1” or more (step S34). When the CPU 10 determines that the number of stored documents is “1” or more(step S34: YES), as shown in FIG. 13C, the CPU 10 sets a count value N of a counter to “1” (step S35). Thereafter, the CPU 10 reads the Nth document information out of the document information contained in the folder file of the top folder (step S36). The CPU 10 determines whether or not security setting information contained in the Nth document information is information indicative of “security setting present” (step S37). In this processing, when the CPU 10 determines that security setting information contained in the Nth document information is information indicative of “security setting present” (step S37: YES), the CPU 10 advances the processing to step S42. On the other hand, when the CPU 10 determines that security setting information contained in the Nth document information is not information indicative of “security setting present” but is information indicative of “security setting not present” (step S37: NO), the CPU 10 advances the processing to step S38.

In step S38, the CPU 10 reads the document file having a document ID which agrees with a document ID contained in the Nth document information from the memory card 8. Then, the CPU 10 stores the title information contained in property information on the document file in a title-list-use predetermined region of the RAM 12 (step S39). Thereafter, the CPU 10 adds “1” to the count value N of the counter (step S40).

Further, in step S42, the CPU 10 determines whether or not a security state of the display device 1 is a security lock state. In this processing, when the CPU 10 determines that the security state of the display device 1 is not a security lock state (step S42: NO), the CPU 10 advances the processing to step S38. On the other hand, when the CPU 10 determines that the security state of the display device 1 is a security lock state (step S42: YES), the CPU 10 reads predetermined information (character string “security document”) stored in the ROM 11 as the title information on the document file having the document ID which agrees with the document ID contained in the Nth document information. The CPU 10 stores the predetermined information in the title list region of the RAM 12 as title list information (step S43), and advances the processing to step S40.

When processing in step S40 is finished, the CPU 10 determines whether or not processing corresponding to the number of stored documents is finished (step S41). When the count value N of the counter becomes equal to the number of stored documents, the CPU 10 determines that processing corresponding to the number of stored documents is finished. In this processing, when the CPU 10 determines that processing corresponding to the number of stored documents is not finished (step S41: NO), the CPU 10 returns the processing to step S36. On the other hand, when the CPU 10 determines that processing corresponding to the number of stored documents is finished (step S41: YES), the CPU 10 displays the title list on the display part 2 based on the title list information stored in the title list region of the RAM 12 (step S44), and finishes “folder list display processing”.

Next, “file display processing” in step S5 is explained in conjunction with FIG. 14A and FIG. 14B. The “file display processing” is executed such that the CPU 10 functions as the display control unit.

As shown in FIG. 14A, when this processing starts, the CPU 10 determines whether or not, out of the security setting information contained in the folder files which is used for generating the title list displayed on the display part 2, the security setting information on the file which the CPU 10 determines to be selected in step S4 (hereinafter referred to as “selected file”) is information indicative of “security setting present” (step S50). In this processing, when the CPU 10 determines that security setting information on the file is information indicative of “security setting present” (step S50: YES), the CPU 10 advances the processing to step S51. On the other hand, when the CPU 10 determines that security setting information on the file is not information indicative of “security setting present” but is information indicative of “security setting not present” (step S50: NO), the CPU 10 advances the processing to step S55.

In step S51, the CPU 10 determines whether or not a security state of the display device 1 is a security lock state. In this processing, when the CPU 10 determines that the security state of the display device 1 is not a security lock state (step S51: NO), the CPU 10 advances the processing to step S58. On the other hand, when the CPU 10 determines that the security state of the display device 1 is a security lock state (step S51: YES), the CPU 10 displays a password input screen on the display part 2, and prompts a user to input a password (step S52). Further, when the user performs an inputting operation of the password using the region selection buttons 6, the CPU 10 determines whether or not the inputted password agrees with a password stored in the RAM 12 (step S53). Here, the CPU 10 determines whether or not the password agrees with the password stored in the RAM 12 based on whether or not the selected file can be decrypted. However, the CPU 10 may determine whether or not the password agrees with the password stored in the RAM 12 in such a manner that document information or folder information contains decryption determination information or the decryption determination information is stored in a predetermined region of the memory card 8, and the decryption determination information can be normally decrypted with the password which the user inputs. In such processing, when the CPU 10 determines that the password agrees with the password stored in the RAM 12 (step S53: YES), the CPU10 stores the decryption key in the RAM 12, and a security state of the display device 1 is set to a security lock released state (step S54), and the CPU 10 advances the processing to step S58.

Further, in step S55, when the CPU 10 determines whether or not the security state of the display device 1 is a security lock state. In this processing, the CPU 10 determines that the security state of the display device 1 is not in a security lock state (step S55: NO), the CPU 10 erases the decryption key stored in the RAM 12, and sets the security state of the display device 1 to a security lock state (step S56). Next, the CPU 10 executes security lock notification for several seconds (step S57) and advances the processing to step S58. The security lock notification is executed by displaying a screen such as a screen shown in FIG. 3E on the display part 2. On the other hand, when the CPU 10 determines that the security state of the display device 1 is a security lock state (step S55: YES), the CPU 10 advances the processing to step S58.

In step S58, the CPU 10 determines whether or not the selected file is the folder file. In this processing, when the CPU 10 determines that the selected file is the folder file (step S58: YES), the CPU 10 advances the processing to step S59. On the other hand, when the CPU 10 determines that the selected file is not the folder file but is the document file (step S58: NO), the CPU 10 advances the processing to step S62.

In step S59, the CPU 10 functions as the information acquisition unit, and reads the folder file which is the selected file from the memory card 8 and stores the folder file in a predetermined region of the RAM 12. Here, when the security setting is given to the folder file which is the selected file, the CPU 10 decrypts the folder file using the decryption key stored in the RAM 12 and stores the decrypted folder file in the RAM 12. Thereafter, as shown in FIG. 14B, the CPU 10 reads title information contained in the folder file stored in the RAM 12 and stores the title information in the title list region as information on the title list (step S60). The CPU 10 displays the title list on the display part 2 based on information on the title list (step S61), and finishes “file display processing”.

In step S62, the CPU 10 functions as the information acquisition unit, and reads the document file which is the selected file from the memory card 8 and stores the document file in a predetermined region of the RAM 12. Here, when the security setting is given to the document file which is the selected file, the CPU 10 decrypts the document file using the decryption key stored in the RAM 12 and stores the decrypted document file in the RAM 12. Thereafter, the CPU 10 reads document data body contained in the document file stored in the RAM 12 and displays the document data body of the document file stored in the RAM 12 on the display part 2 (step S63), and finishes “file display processing”.

Next, “browsing history display processing” in step S8 is explained in conjunction with FIG. 15A and FIG. 15B. The “browsing history display processing” is executed by the CPU 10 which functions as the display control unit.

When this processing starts, as shown in FIG. 15A, firstly, the CPU 10 reads information on the number of registered browsing histories from a browsing history file stored in the RAM 12 (step S70). The CPU 10 determines whether or not the number of registered browsing histories is “1” or more (step S71). When the CPU 10 determines that the number of registered browsing histories is “1” or more (step S71: YES), the CPU 10 sets a count value X of a counter to “1” (step S72). Thereafter, the CPU 10 reads the Xth browsing document information out of browsing document information contained in the browsing history file (step S73). The CPU 10 determines whether or not security setting information contained in the browsing document information is information indicative of “security setting present” (step S74). In this processing, when the CPU 10 determines that the security setting information contained in the browsing document information is information indicative of “security setting present” (step S74: YES), the CPU 10 advances the processing to step S79. On the other hand, when the CPU 10 determines that the security setting information contained in the browsing document information is not information indicative of “security setting present” but is information indicative of “security setting not present” (step S74: NO), the CPU 10 advances the processing to step S75.

In step S75, the CPU 10 reads a document file having a document ID which agrees with the document ID contained in the Xth browsing document information from the memory card 8. Then, the CPU 10 stores the title information contained in property information on the document file in the title list region of the RAM 12 (step S76). Thereafter, the CPU 10 adds “1” to the count value X of the counter (step S77).

Further, in step S79, the CPU 10 determines whether or not a security state of the display device 1 is a security lock state. In this processing, when the CPU 10 determines that the security state of the display device 1 is not a security lock state (step 79: NO), the CPU 10 advances the processing to step S75. On the other hand, when the CPU 10 determines that the security state of the display device 1 is a security lock state (step S79: YES), the CPU 10 reads predetermined information (character string “security document”) stored in the ROM 11 as title information on the document file having the document ID which agrees with the document ID contained in the Xth document information. The CPU 10 stores the predetermined information as information on the title list in the title list region of the RAM 12 (step S80), and advances the processing to step S77.

When the processing in step S77 is finished, as shown in FIG. 15B, the CPU 10 determines whether or not the processing corresponding to the number of registered browsing histories is finished (step S78). Here, when the count value X of the counter becomes equal to the number of registered browsing histories, the CPU 10 determines that the processing corresponding to the number of registered browsing histories is finished. In this processing, when the CPU 10 determines that the processing corresponding to the number of registered browsing histories is not finished (step S78: NO), the CPU 10 returns the processing to step S73. On the other hand, when the CPU 10 determines that the processing corresponding to the number of registered browsing histories is finished (step S78: YES), based on the information on the title list stored in the title list region of the RAM 12, the CPU 10 displays the title list on the display part 2 (step S79), and finishes the “browsing history display processing”.

Next, “browsing document display processing” in step S12 is explained in conjunction with FIG. 16A and FIG. 16B.

As shown in FIG. 16A, when this processing starts, the CPU 10 determines whether or not security setting information on the browsing document information which is determined to be selected in step S11 (hereinafter referred to as “selected document”) out of the browsing document information contained in the browsing history file is information indicative of “security setting present” (step S90). In this processing, when the CPU 10 determines that the security setting information is information indicative of “security setting present” (step S90: YES), the CPU 10 advances the processing to step S91. On the other hand, when the CPU 10 determines that the security setting information is not information indicative of “security setting present” but is information indicative of “security setting not present” (step S90: NO), the CPU 10 advances the processing to step S95.

In step S91, the CPU 10 determines whether or not a security state of the display device 1 is a security lock state. In this processing, when the CPU 10 determines that the security state of the display device 1 is not a security lock state (step S91: NO), the CPU 10 advances the processing to step S98. On the other hand, when the CPU 10 determines that the security state of the display device 1 is a security lock state (step S91: YES), the CPU 10 displays the password input screen on the display part 2, and prompts the user to input password (step S92). When the user performs the input operation of password using the region selection button 6, the CPU 10 determines whether or not the inputted password agrees with the password stored in the RAM 12 (step S93). Here, the CPU 10 determines whether or not the password agrees with the password stored in the RAM 12 based on whether or not the document file of the selected document can be decrypted. However, the CPU 10 may determine whether or not the password agrees with the password stored in the RAM 12 in such a manner that the document information contains decryption determination information, or the decryption determination information is stored in a predetermined region of the memory card 8, and the decryption determination information can be normally decrypted with the password which the user inputs. In this processing, when the CPU 10 determines that the password agrees with the password stored in the RAM 12 (step S93: YES), the CPU 10 sets the security state of the display device 1 to the security lock released state (step S94), and advances the processing to step S98.

Further, in step S95, the CPU 10 determines whether or not a security state of the display device 1 is a security lock state. In this processing, when the CPU 10 determines that the security state of the display device 1 is not a security lock state (step S95: NO), the CPU 10 erases the decryption key stored in the RAM 12, and sets the security state of the display device 1 to a security lock state (step S96). Thereafter, the CPU 10 executes the security lock notification for several seconds (step S97), and advances the processing to step S98. The security lock notification is executed by displaying a screen such as a screen shown in FIG. 4F on the display part 2. On the other hand, when the CPU 10 determines that the security state of the display device 1 is a security lock state (step S95: YES), the CPU 10 advances the processing to step S98.

In step S98, the CPU 10 functions as the information acquisition unit, and reads the document file of the selected document from the memory card 8 and stores the document file in the predetermined region of the RAM 12. Here, when the security setting is given to the document file which is the selected document, the CPU 10 decrypts the document file using the decryption key stored in the RAM 12 and stores the decrypted document file in the RAM 12. Thereafter, as shown in FIG. 16B, the CPU 10, using the latest browsing document information in the browsing history file as the document file of the selected document, sets the document ID of the document file or the like as the latest browsing document information in the browsing history file (step S99).

When the processing in step S99 is finished, the CPU 10 reads the document data body of the selected document from the RAM 12, and displays the document data body on the display part 2 (step S100), and finishes “browsing document display processing”.

Several embodiments of the present invention have been explained in detail in conjunction with drawings heretofore. However, these embodiments are provided as merely examples, and the present invention can be carried out in other modes where various modifications or improvements are applied to these embodiments based on the knowledge of those who are skilled in the art.

For example, as the predetermined information which replaces the title information on the document files or the folder files to which security setting is given, the character string such as “security document” or “security folder” is used. However, the predetermined information may be formed using figures or the like.

Further, in the above-mentioned embodiments, the explanation has been made with respect to the case where the encryption number used in decryption is used in common among the folder files and the document files in the top folder. However, an encryption number may be given to each file individually. Here, each time the document file to which security setting is given is selected out of the document files corresponding to browsing document information, inputting of the encryption number is requested so that the security state is brought into a security lock release state by such inputting of the encryption number, while each time the document file is closed, the security state is shifted to a security lock state from a security lock release state.

Further, in the above-mentioned embodiments, the explanation has been made with respect to the case where the browsing history files and the data files (document files and folder files) are stored in the detachable memory card 8. However, a volatile memory having sufficient capacity may be mounted in the display device 1, and the browsing history files and the data files may be stored in the volatile memory.

Further, in the above-mentioned embodiments, the encryption number inputted by the user is used as the decryption key. However, the present invention is not limited to such a case. For example, a decryption key (first key+second key) may be formed by combining an encryption number inputted by the user (first key) and information stored in the ROM 11 or the like of the display device 1 (second key). For example, assuming the encryption number as “1234” and the information stored in the display device 1 as “5678”, “12345678” becomes the encryption key.

What is claimed is:

1. A display device comprising:
a display unit;
an information acquisition unit which is configured to acquire list information containing title information on a plurality of data files or information corresponding to the title information; and
a display control unit which is configured to display a title list which is a list of the title information on the data files based on the list information acquired by the information acquisition unit on the display unit, wherein
the list information contains information on security setting for every data file, and
the display control unit is configured to, in displaying the title list on the display unit, display predetermined information in place of the title information based on the information on security setting with respect to the data file to which security setting is given.

2. A display device according to claim 1, wherein the list information is associated with a file ID and information on security setting for every said data file,
the data file includes file data and property information which contains file ID and title information,
the information acquisition unit is configured to acquire the data file and the list information from a memory medium which stores the data file and the list information therein through a memory medium drive, and
the display control unit is configured to acquire title information contained in data file having a file ID which agrees with a file ID of the data file to which the security setting is given based on information on security setting, and to acquire the predetermined information in place of the title information with respect to the data file to which security setting is given, and to generate and display the title list.

3. A display device according to claim 2, further comprising an input unit which is configured to input release information for displaying title information on data file to which the security setting is given, wherein
the title information on the data file to which the security setting is given is encrypted and the encrypted title information is stored in the memory medium,
the display control unit is configured, in displaying the title list after the release information is inputted by the input unit, to decrypt the title information on the data file to which the security setting is given so as to acquire the title information of the data file to which the security setting is given, and to generate and display the title list containing the title information on the data file to which the security setting is given.

4. A display device according to claim 1, further comprising a selection unit which is configured to select the data file from the title list which is displayed on the display unit, wherein
the display control unit is configured, when the data file selected by the selection unit is the data file to which the security setting is given, to prohibit a display of the file data contained in the data file.

5. A display device according to claim 4, further comprising an input unit which is configured to input release information for displaying file data of the data file to which the security setting is given, wherein
the information acquisition unit is configured to acquire the data file and the list information from the memory medium which stores the data file and the list information therein through the memory medium drive,
the data file to which the security setting is given is encrypted and the encrypted data file is stored in the memory medium; and
the display control unit is configured to perform a display which prompts inputting of the release information when the data file selected by the selection unit is the data file to which security setting is given and, thereafter, file data of the selected data file is decrypted and displayed when the release information is inputted to the display control unit from the input unit.

6. A display device according to claim 1, the list information contains information relating to the folder which stores the data file therein and, further, the information relating to the folder contains information on security setting of the folder, and
the display control unit displays predetermined information in place of the title information with respect to the folder to which security setting is given when the title list which contains the title information on the folder is displayed on the display unit.
